(19) United States
(12) Patent Application Publication
(10) Pub. No.: US 2024/0409726 A1
(43) Pub. Date: Dec. 12, 2024

(54) SULFUR-CROSSLINKABLE RUBBER MIXTURE, VULCANIZATE OF THE RUBBER MIXTURE, AND VEHICLE TYRE

(71) Applicant: CONTINENTAL REIFEN DEUTSCHLAND GMBH, Hannover (DE)

(72) Inventors: Frank Hengesbach, Datteln (DE); Julia Große, Seelze (DE)

(73) Assignee: Continental Reifen Deutschland GmbH, Hannover (DE)

(21) Appl. No.: 18/702,669

(22) PCT Filed: Oct. 13, 2022
(86) PCT No.: PCT/DE2022/200235

§ 371 Date: Apr. 18, 2024

(30) Foreign Application Priority Data
Oct. 27, 2021 (DE) 10 2021 212 138.1

(51) Int. Cl. C08L 9/00; B60C 1/00; C08J 3/20; C08K 5/3437; C08L 7/00

(52) U.S. Cl. CPC C08L 9/00; B60C 1/0016; B60C 1/0025; C08J 3/203; C08K 5/3437; C08L 7/00; C08J 2307/00; C08J 2309/00; C08J 2407/00; C08J 2409/00; C08L 2312/00

(57) ABSTRACT

A sulfur-crosslinkable rubber mixture and a process for producing the sulfur-crosslinkable rubber mixture, in which the sulfur-crosslinkable rubber mixture contains at least the following constituents: a) 30 to 95 phr of at least one butadiene rubber; and b) 5 to 70 phr of at least one further rubber; and c) 0.1 to 3.0 phr of an oligomer mixture of 2,2,4-trimethyl-1,2-dihydroquinoline, wherein the mixture contains 70% to 100% by weight of dimers and trimers of 2,2,4-trimethyl-1,2-dihydroquinoline.

### TECHNICAL FIELD

The invention relates to a sulfur-crosslinkable rubber mixture, to the vulcanizate thereof, and to a vehicle tire. The invention further relates to a process for producing the sulfur-crosslinkable rubber mixture and to the use of the sulfur-crosslinkable rubber mixture.

### BACKGROUND

It is known that rubber mixtures for vehicle tires and other technical rubber articles have aging stabilizers added to them. Antioxidants, which include polymerized 2,2,4-trimethyl-1,2-dihydroquinoline, play a particular role. Commercially available 2,2,4-trimethyl-1,2-dihydroquinoline, TMQ for short, is present in the form of an oligomer mixture, aging stabilization being effected especially by the dimer and the trimer.

The disadvantage of aging stabilizers is that these can exhibit blooming and thus bring about discoloration of the rubber articles.

EP 3517570 A1 discloses the use of the aging stabilizer N-phenyl-N′-(1,3-dimethylbutyl)-p-phenylenediamine (6PPD) in conjunction with an oligomer mixture of 2,2,4-trimethyl-1,2-dihydroquinoline, wherein the mixture contains 61% by weight of dimers and trimers of 2,2,4-trimethyl-1,2-dihydroquinoline.

Such a system of aging stabilizers is said to achieve an improvement in blooming characteristics and resistance to cracking. Further tire properties, such as handling characteristics, wet grip, abrasion characteristics and rolling resistance characteristics, are likewise said to be improved at the same time.

Comparing the mixtures containing either a mixture containing 35% by weight of dimers and trimers of TMQ or a mixture containing 61% by weight of dimers and trimers of TMQ with otherwise identical constituents shows no effect on rolling resistance.

JP 6642067 B2 discloses a rubber mixture containing 100 phr of natural rubber (NR) and inter alia an oligomer mixture of 2,2,4-trimethyl-1,2-dihydroquinoline, wherein the mixture contains 70% to 97% by weight of dimers and trimers of 2,2,4-trimethyl-1,2-dihydroquinoline. According to JP 6642067 B2 this is said to prevent conversion of insoluble sulfur into soluble sulfur and thus achieve an improvement in steel cord adhesion by preventing blooming of sulfur combined with good processability and heat resistance.

### SUMMARY

It was an object of the present invention to provide a rubber mixture which, compared to the prior art, exhibits a further improvement in rolling resistance characteristics and in handling characteristics, in particular a higher stiffness.

The object is achieved by the sulfur-crosslinkable rubber mixture as claimed in claim 1 and the process for producing a sulfur-crosslinkable rubber mixture as claimed in claim 13.

It was likewise an object of the present invention to provide a vulcanizate and a vehicle tire exhibiting improved rolling resistance characteristics and handling characteristics.

This object is achieved by the vulcanizate as claimed in claim 10 and the vehicle tire as claimed in claim 11.

It was a further object of the present invention to provide technical rubber articles, such as bellows, conveyor belts, air springs, belts, drive belts or hoses, and also shoe soles which feature an improvement in handling characteristics and in heat buildup.

This object is achieved by the use of the sulfur-crosslinkable rubber mixture according to the invention for the production of the recited technical rubber articles.

The rubber mixture according to the invention containing a combination of a) 30 to 95 phr of at least one butadiene rubber and c) 0.1 to 3.0 phr of an oligomer mixture of TMQ, wherein the mixture contains 70% to 100% by weight of dimers and trimers of TMQ, surprisingly exhibits a further improvement over the prior art in terms of heat buildup and thus rolling resistance characteristics as well as stiffness and thus handling characteristics.

It is especially also an advantage of the present invention that it is possible to reduce, in particular halve, the amount of employed oligomer mixture of TMQ while at the same time improving the rolling resistance of the rubber mixture and leaving the aging characteristics unchanged, the oligomer mixture thus exhibiting a comparable activity in a reduced, in particular halved, amount.

Several embodiments even also surprisingly exhibit improved tear characteristics, in particular improved fatigue resistance, in particular with respect to cracking and optionally fracture, after aging.

### DETAILED DESCRIPTION

The invention comprises all advantageous embodiments which are reflected inter alia in the patent claims. The invention especially also comprises embodiments which result from a combination of different features, for example of constituents of the rubber mixture, with different levels of preference for these features so that the invention also comprises a combination of a first feature described as “preferred” or described in the context of an advantageous embodiment with a further feature described for example as “particularly preferred”.

There follows a detailed description of the constituents of the sulfur-crosslinkable rubber mixture of the invention.

All indications regarding the constituents of the rubber mixture according to the invention at any level of preference of these features correspondingly apply likewise to the process according to the invention for producing the sulfur-crosslinkable rubber mixture and to the vulcanizate according to the invention, the vehicle tires according to the invention and the use according to the invention.

The unit “phr” (parts per hundred parts of rubber by weight) used in this document is the standard unit of quantity for mixture recipes in the rubber industry. In this document, the dosage of the parts by weight of the individual substituents is based on 100 parts by weight of the total mass of all rubbers present in the mixture that have a molecular weight Mw by GPC of greater than 20000 g/mol.

According to the invention the rubber mixture a) contains 30 bis 95 phr of at least one butadiene rubber (═BR, polybutadiene). The rubber may in principle be any of the types known to those skilled in the art. These include the so-called high-cis and low-cis types, wherein poly butadiene having a cis content of not less than 90% is known as high-cis type and polybutadiene having a cis content of less than 90% is known as low-cis type. An example of a low-cis polybutadiene is Li—BR (lithium-catalyzed butadiene rubber) having a cis content of 20% to 50%. Particularly good properties and low hysteresis of the rubber mixture are achieved with a high-cis BR.

It is therefore preferable when the at least one butadiene rubber a) has a cis-1,4 content of 90% to 98%, preferably 94% to 98%.

The reported FIGURES in % relate to the monomers of the polymer chain of the poly butadiene.

The cis content of polybutadiene is determined by ¹³C-NMR (125.77 MHz: relaxation agent Cr(acac) 3: solvent CDCl₃, Bruker 500 MHz).

It is preferable when the rubber mixture contains 40 to 95 phr, particularly preferably 50 to 95 phr, of at least one butadiene rubber.

The object of the invention is achieved particularly well especially with an elevated amount of at least one butadiene rubber, such as especially 50 bis 95 phr.

The polybutadiene(s) employed may be end group-modified with modifications and functionalizations and/or be functionalized along the polymer chains. The modification may be selected from modifications with hydroxyl groups and/or ethoxy groups and/or epoxy groups and/or siloxane groups and/or amino groups and/or aminosiloxane and/or carboxyl groups and/or phthalocyanine groups and/or silane-sulfide groups. Metal atoms may also be a constituent of functionalizations.

According to the invention the sulfur-crosslinkable rubber mixture b) contains 5 to 70 phr of at least one further rubber, wherein this is in particular a further rubber type.

It is apparent to a person skilled in the art that the sum of the employed rubbers, as mentioned above, is 100 phr and so the amount of further rubber/further rubbers in the case of 40 to 95 phr, particularly preferably 50 to 95 phr, of at least one butadiene rubber is accordingly 5 to 60 phr, particularly preferably 5 to 50 phr.

The further rubber (b) may in principle be any rubber type known to a person skilled in the art.

However it is preferable when the at least one further rubber b) is at least one diene rubber.

Such a rubber mixture is particularly suitable for vehicle tires, in particular for their external components.

Diene rubbers are rubbers which are formed by polymerization or copolymerization of dienes and/or cycloalkenes and thus have C═C double bonds either in the main chain or in the side groups.

The further diene rubber is preferably selected from the group consisting of natural polyisoprene (NR), synthetic polyisoprene (IR), epoxidized polyisoprene (ENR), butadiene-isoprene rubber, styrene-butadiene rubber (SBR), in particular solution-polymerized styrene-butadiene rubber (SSBR) and emulsion-polymerized styrene-butadiene rubber (ESBR), styrene-isoprene rubber, liquid rubbers having a molecular weight Mw of more than 20000 g/mol, halobutyl rubber, polynorbornene, isoprene-isobutylene copolymer, ethylene-propylene-diene rubber, nitrile rubber, chloroprene rubber, acrylate rubber, fluoro rubber, silicone rubber, polysulfide rubber, epichlorohydrin rubber, styrene-isoprene-butadiene terpolymer, hydrogenated acrylonitrile butadiene rubber and hydrogenated styrene-butadiene rubber.

Nitrile rubber, hydrogenated acrylonitrile-butadiene rubber, chloroprene rubber, butyl rubber, halobutyl rubber or ethylene-propylene-diene rubber in particular are used in the production of technical rubber articles, such as belts, drive belts and hoses, and/or shoe soles. The mixture compositions known to those skilled in the art for these rubbers, which are specific in terms of fillers, plasticizers, vulcanization systems and additives, are preferably employed.

The natural and/or synthetic polyisoprene may be either cis-1,4-polyisoprene or 3,4-polyisoprene. However, preference is given to the use of cis-1,4-polyisoprene having a cis-1,4 content >90%. Such a polyisoprene is firstly obtainable by stereospecific polymerization in solution with Ziegler-Natta catalysts or using finely divided lithium alkyls. Secondly, natural rubber (NR) is one such cis-1,4-polyisoprene, for which the cis-1,4 content in the natural rubber is greater than 99% by weight.

A mixture of one or more natural polyisoprenes with one or more synthetic polyisoprenes is further also conceivable.

In the context of the present invention the term “natural rubber” is to be understood as meaning naturally occurring rubber which may be obtained from Hevea rubber trees and from “non-Hevea” sources. Non-Hevea sources include for example guayule shrubs and dandelion such as for example TKS (Taraxacum kok-saghyz: Russian dandelion).

In the case where at least one styrene-butadiene rubber (styrene-butadiene copolymer) is present in the rubber mixture, this may be selected from solution-polymerized styrene-butadiene rubber (SSBR) and emulsion-polymerized styrene-butadiene rubber (ESBR), a mixture of at least one SSBR and at least one ESBR also being employable. The terms “styrene-butadiene rubber” and “styrene-butadiene copolymer” are used synonymously in the context of the present invention.

The styrene-butadiene copolymer used may be end group-modified and/or modified along the polymer chains with the modifications and functionalizations recited above for the polybutadiene.

The diene rubber is particularly preferably selected from the group consisting of natural polyisoprene (NR) and synthetic polyisoprene (IR) and styrene-butadiene rubber (SBR), wherein the styrene-butadiene rubber is preferably selected from SSBR.

In advantageous embodiments of the invention the rubber mixture contains a) 30 to 95 phr of at least one butadiene rubber and b) 5 to 70 phr of at least one styrene-butadiene rubber (SBR), wherein the styrene-butadiene rubber is preferably selected from SSBR.

In further advantageous embodiments of the invention the rubber mixture contains a) 30 to 95 phr of at least one butadiene rubber and

b) 5 to 70 phr of at least one styrene-butadiene rubber (SBR), wherein the styrene-butadiene rubber is preferably selected from SSBR, and at least one polyisoprene selected from natural polyisoprene (NR) and synthetic polyisoprene (IR), wherein at least one natural polyisoprene is preferred. In these embodiments of the invention the rubber mixture thus contains at least three different polymers, especially preferably BR, NR and SSBR.

In particularly advantageous embodiments of the invention the rubber mixture contains a) 30 to 95 phr of at least one butadiene rubber and b) 5 to 70 phr of at least one polyisoprene selected from natural polyisoprene (NR) and synthetic polyisoprene (IR), wherein at least one natural polyisoprene is preferred.

In particularly advantageous embodiments of the invention the rubber mixture contains a) 40 to 60 phr, preferably 45 to 55 phr, in particular 50 phr, of at least one butadiene rubber and b) 40 to 60 phr, 45 to 55 phr, in particular 50 phr, of at least one natural polyisoprene (NR).

This surprisingly makes it possible to achieve better rolling resistance characteristics and improved tear characteristics, in particular improved fatigue resistance, in particular with respect to cracking and optionally fracture, after aging.

In particularly advantageous embodiments of the invention the rubber mixture contains as rubber b) 5 to 40 phr of natural polyisoprene (NR).

This solves the object of the invention particularly well and the rubber mixture exhibits optimal processability and optimal further properties, in particular tear properties and abrasion properties.

In particularly advantageous embodiments of the invention the sulfur-crosslinkable rubber mixture contains a) 60 to 80 phr of at least one butadiene rubber and b) 20 to 40 phr of at least one natural polyisoprene (NR). It is preferable when the amounts of rubbers a) and b) sum to 100 phr.

It is otherwise clear to a person skilled in the art that in the case of a mixture containing for example 60 phr of butadiene rubbers (BR) and 20 phr of natural rubbers (NR), the mixture must still contain 20 phr of one or more further rubber(s) in order for the amounts to sum to 100 phr.

According to the invention the sulfur-crosslinkable rubber mixture contains

c) 0.1 to 3.0 phr of an oligomer mixture of 2,2,4-trimethyl-1,2-dihydroquinoline, wherein the mixture contains 70% to 100% by weight of dimers and trimers of 2,2,4-trimethyl-1,2-dihydroquinoline.

As mentioned above, 2,2,4-trimethyl-1,2-dihydroquinoline is also referred to as “TMQ” for short.

As described at the outset, 2,2,4-trimethyl-1,2-dihydroquinoline, which is commercially available as an aging stabilizer, is present in polymerized form, wherein the dimer and the trimer have been identified as the active components in aging stabilization.

According to general understanding in the art an “oligomer” is a molecule constructed from “few” (Greek “oligos”=few) parts (Greek “méros”=part).

The oligomer mixture c) present in the rubber mixture according to the invention contains at least dimers and trimers of TMQ as oligomers.

It is preferable when the oligomer mixture c) contains 73% to 100% by weight, preferably 74% to 100% by weight, particularly preferably 74% to 95% by weight, very particularly preferably 74% to 85% by weight, of dimers and trimers of 2,2,4-trimethyl-1,2-dihydroquinoline.

This achieves the object of the invention particularly well.

In the event that the oligomer mixture contains less than 100% by weight of dimers and trimers of 2,2,4-trimethyl-1,2-dihydroquinoline, further substances are present in the mixture.

The further substances especially comprise byproducts with reduced aging stabilizer activity, in particular tetramers and higher homologs, aniline, isopropylidene bis aniline, the monomer 2,2,4-trimethyl-1,2-dihydroquinoline.

It is preferable when the oligomer mixture contains the substance isopropylide bis aniline in an amount of less than 0.05% by weight, more preferably less than 0.02% by weight, particularly preferably less than 0.01% by weight, in turn preferably 0% to 0.0099% by weight.

This achieves the object of the invention particularly well.

The oligomer mixture preferably contains the monomer 2,2,4-trimethyl-1,2-dihydroquinoline in an amount of less than 0.7% by weight, more preferably 0% to 0.5% by weight.

This achieves the object of the invention particularly well.

It is preferable when the rubber mixture contains the oligomer mixture c) in an amount of 0.2 to 3 phr, particularly preferably 0.2 to 2.5 phr, very particularly preferably 0.4 to 2.2 phr.

The object of the invention is achieved particularly well with such preferred, particularly preferred and very particularly preferred amounts. They result in particular in improved rolling resistance properties at identical aging stabilization.

It is preferable when the rubber mixture contains d) at least one filler preferably in amounts of 20 to 500 phr, particularly preferably 20 to 400 phr, in turn preferably 20 to 180 phr, very particularly preferably 45 to 180 phr.

It is preferable when the filler is a reinforcing filler which is preferably selected from the group consisting of carbon blacks and silicon dioxide.

In advantageous embodiments the rubber mixture according to the invention contains 20 to 500 phr, particularly preferably 20 to 400 phr, in turn preferably 20 to 180 phr, very particularly preferably 45 to 180 phr, of at least one carbon black.

The at least one carbon black is preferably selected from industrial carbon blacks and pyrolysis carbon blacks, wherein industrial carbon blacks are more preferred.

Suitable carbon blacks include any carbon black types known to those skilled in the art.

It is preferable when the carbon black has an iodine number according to ASTM D 1510, also known as the iodine adsorption number, between 30 and 250 g/kg, preferably 30 to 180 g/kg, particularly preferably 40 to 180 g/kg, and very particularly preferably 40 to 130 g/kg, and a DBP number according to ASTM D 2414 of 30 to 200 ml/100 g, preferably 70 to 200 ml/100 g, particularly preferably 90 to 200 ml/100 g.

The DBP number in accordance with ASTM D 2414 determines the specific absorption volume of a carbon black or a light-colored filler by means of dibutyl phthalate.

The use of such a type of carbon black in the rubber mixture, in particular for vehicle tires, ensures the best possible compromise between abrasion resistance and heat buildup, which in turn influences the ecologically relevant rolling resistance.

A particularly suitable and preferred carbon black is one having an iodine adsorption number between 80 and 110 g/kg and a DBP number of 100 to 130 ml/100 g, such as in particular carbon blacks of the type N339.

In advantageous embodiments the rubber mixture according to the invention contains 20 to 500 phr, particularly preferably 20 to 400 phr, in turn preferably 20 to 180 phr, of at least one silicon dioxide.

The silicon dioxide is preferably amorphous silicon dioxide, for example precipitated silica, which is also referred to as precipitated silicon dioxide. However, it is alternatively also possible to employ pyrogenic silicon dioxide for example.

However, particular preference is given to using a finely divided, precipitated silica which has a nitrogen surface area (BET surface area) (according to DIN ISO 9277 and DIN 66132) of 35 to 400 m²/g, preferably of 35 to 350 m²/g, particularly preferably of 85 to 320 m²/g and very particularly preferably of 120 to 235 m²/g and a CTAB surface area (according to ASTM D 3765) of 30 to 400 m²/g, preferably of 30 to 330 m²/g, particularly preferably of 80 to 300 m²/g and very particularly preferably of 115 to 200 m²/g. Such silicas lead, for example in rubber mixtures for tire treads, to particularly good physical properties of the vulcanizates. Advantages in mixture processing by way of a reduction in mixing time can also result here while retaining the same product properties, leading to improved productivity. Silicas used may thus, for example, be either those of the Ultrasil® VN3 type (trade name) from Evonik or highly dispersible silicas known as HD silicas (e.g. Zeosil® 1165 MP from Solvay).

It is also possible to use silicas obtained from the residue of combustion of rice hulls.

The rubber mixture may additionally contain further fillers which are reinforcing or non-reinforcing.

Within the context of the present invention, the further (non-reinforcing) fillers include aluminosilicates, kaolin, chalk, starch, magnesium oxide, titanium dioxide, or rubber gels and also fibers (for example aramid fibers, glass fibers, carbon fibers, cellulose fibers).

Further optionally reinforcing fillers are, for example, carbon nanotubes ((CNT), including discrete CNTs, what are called hollow carbon fibers (HCF) and modified CNTs containing one or more functional groups, such as hydroxyl, carboxyl and carbonyl groups), graphite and graphene, and so-called “carbon-silica dual-phase fillers”.

In the context of the present invention zinc oxide is not included among the fillers.

The rubber mixture may further contain customary additives in customary parts by weight which are added preferably in at least one primary mixing stage during the production of said mixture. These additives include
e) further aging stabilizers, for example diamines, such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-(1,4-dimethylpentyl)-N′-phenyl-p-phenylenediamine (7PPD), N-isopropyl-N′-phenyl-p-phenylenediamine (IPPD),
and/or substituted bisphenols, such as 2,2′-methylenebis(4-methyl-6-tert-butylphenol) (BPH), and/or substituted phenols, such as butylhydroxytoluene (BHT),
f) activators, for example zinc oxide and fatty acids (for example stearic acid) and/or other activators, such as zinc complexes, for example zinc ethylhexanoate,
g) activators and/or agents for binding fillers, in particular carbon black or silicon dioxide, for example S-(3-aminopropyl)thiosulfuric acid and/or metal salts thereof (bonding of carbon black) and silane coupling agents (binding to silicon dioxide, in particular silica),
h) antiozonant waxes,
i) resins, such as especially phenolic resins, in particular as adhesive resins,
j) masticating aids, for example 2,2′-dibenzamidodiphenyl disulfide (DBD), and
k) processing aids, such as in particular fatty acid esters and metal soaps, for example zinc soaps and/or calcium soaps,
l) plasticizers, such as in particular aromatic, naphthenic or paraffinic mineral oil plasticizers, for example MES (mild extraction solvate) or RAE (residual aromatic extract) or TDAE (treated distillate aromatic extract), or rubber-to-liquid oils (RTL) or biomass-to-liquid oils (BTL) preferably having a content of polycyclic aromatics of less than 3% by weight according to method IP 346 or triglycerides, for example rapeseed oil or factices or hydrocarbon resins or liquid polymers having a mean molecular weight (determination by GPC=gel permeation chromatography, in accordance with BS ISO 11344:2004) between 500 and 20000 g/mol.

When using mineral oil this is preferably selected from the group consisting of DAE (distillated aromatic extracts), RAE (residual aromatic extract), TDAE (treated distillated aromatic extracts), MES (mild extracted solvents) and naphthenic oils.

In advantageous embodiments of the invention the sulfur-crosslinkable rubber mixture e) contains at least one further aging stabilizer, particularly preferably selected from the group of diamines, for example N-phenyl-N′-(1,3-dimethylbutyl)-p-phenylenediamine (6PPD).

In advantageous embodiments of the invention the sulfur-crosslinkable rubber mixture contains further aging stabilizers e) in an amount of 0.5 to 4 phr, particularly preferably 0.5 to 2.5 phr.

In advantageous embodiments of the invention the sulfur-crosslinkable rubber mixture contains no further aging stabilizer, in particular 0 phr of diamines, for example N-phenyl-N′-(1,3-dimethylbutyl)-p-phenylenediamine (6PPD).

The silane coupling agents may be any of the types known to those skilled in the art.

Furthermore, one or more different silane coupling agents may be used in combination with one another. The rubber mixture may thus contain a mixture of different silanes.

The silane coupling agents react with the surface silanol groups of the silicon dioxide, in particular of the silica, or other polar groups during the mixing of the rubber/the rubber mixture (in situ) or in the context of a pretreatment (premodification) even before addition of the filler to the rubber.

Coupling agents known from the prior art are bifunctional organosilanes having at least one alkoxy, cycloalkoxy or phenoxy group as a leaving group on the silicon atom and having as another functionality a group which, possibly after cleavage, can enter into a chemical reaction with the double bonds of the polymer. The latter group may for example comprise the following chemical groups:

—SCN, —SH, —NH₂ or —Sₓ— (with x=2 to 8).

Employable silane coupling agents thus include for example 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide (TESPD), or else mixtures of the sulfides having 1 to 8 sulfur atoms with different contents of the various sulfides. TESPT may for example also be added as a mixture with industrial carbon black (trade name X50SR) from Evonik).

Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. Employable silanes include for example those marketed by Momentive, USA in a number of variants under the name NXT, such as especially 3-octanoylthio-1-propyltriethoxysilane, or those marketed by Evonik Industries under the name VP Si 363®.

The total proportion of further additives is preferably 3 to 150 phr, more preferably 3 to 100 phr and most preferably 5 to 80 phr.

Zinc oxide (ZnO) may be included in the total proportion of further additives in the abovementioned amounts.

This may be any type of zinc oxide known to those skilled in the art, for example ZnO pellets or powder. The zinc oxide conventionally used generally has a BET surface area of less than 10 m²/g. However, it is also possible to use a zinc oxide having a BET surface area of 10 to 100 m²/g, for example so-called “nano zinc oxides”.

The inventive rubber mixture is preferably employed in vulcanized form, in particular in vehicle tires or other vulcanized technical rubber articles.

The terms “vulcanized” and “crosslinked” are used synonymously in the context of the present invention.

The vulcanization of the rubber mixture of the invention is preferably conducted in the presence of sulfur and/or sulfur donors with the aid of vulcanization accelerators, it being possible for some vulcanization accelerators to act simultaneously as sulfur donors. The accelerator is selected from the group consisting of thiazole accelerators, mercapto accelerators, sulfenamide accelerators, thiocarbamate accelerators, thiuram accelerators, thiophosphate accelerators, thiourea accelerators, xanthogenate accelerators and guanidine accelerators.

It is preferable to use at least one sulfenamide accelerator selected from the group consisting of N-cyclohexyl-2-benzothiazolesulfenamide (CBS),

N,N-dicyclohexylbenzothiazole-2-sulfenamide (DCBS), benzothiazyl-2-sulfenmorpholide (MBS), N-tert-butyl-2-benzothiazylsulfenamide (TBBS), N-tert-butyl-2-benzothiazolesulfenimide (TBSI) and/or at least one guanidine accelerator, such as diphenylguanidine (DPG).

It is especially also possible to employ two or more accelerators.

The sulfur donor substance used may be any sulfur donor substances known to those skilled in the art.

The rubber mixture may further employ one or more reversion stabilizers, for example 1,6-bis(N,N-dibenzylthiocarbamoyldithio) hexane,
hexamethylene-1,6-bis(thiosulfate) disodium salt dihydrate
and/or tetrabenzyl thiuram disulfide (TBzTD).
Vulcanization retarders may also be present in the rubber mixture.

Production of the rubber mixture is otherwise carried out by the process customary in the rubber industry comprising initially producing in one or more mixing stages a primary mixture comprising all constituents except the vulcanization system (for example sulfur and vulcanization-influencing substances). The finished mixture is produced by adding the vulcanization system in a final mixing stage.

The final mixture is subjected to further processing and brought into the appropriate shape for example by an extrusion procedure or calendering.

The rubber mixture according to the invention is particularly suitable for use in vehicle tires, especially pneumatic vehicle tires. Use in all tire components is conceivable in principle, in particular in an outer component, in particular and preferably in the flange profile, tread and/or sidewall. In the case of a tread with cap/base construction, the rubber mixture according to the invention is preferably used at least in the cap.

For use in vehicle tires the mixture as a finished mixture prior to vulcanization is brought into the corresponding shape, preferably of a flange profile, a sidewall and/or a tread, and during production of the green vehicle tire is applied in the known manner.

Production of the rubber mixture according to the invention for use as any other body mixture in vehicle tires is carried out as described above. The difference lies in the shaping after the extrusion operation/the calendering of the mixture. The shapes thus obtained of the as-yet unvulcanized rubber mixture for one or more different body mixtures then serve for the construction of a green tire.

“Body mixture” refers here to the rubber mixtures for the other components of a tire, such as essentially the squeegee, inner liner (inner layer), core profile, belt, shoulder, belt profile, carcass, bead reinforcement, bead profile and bandage. For use of the rubber mixture according to the invention in drive belts and other belts, especially in conveyor belts, the extruded, as-yet unvulcanized mixture is brought into the appropriate shape and often provided at the same time or subsequently with strength members, for example synthetic fibers or steel cords.

This is followed by further processing by vulcanization.

As mentioned above, the present invention also provides a vulcanizate obtained by sulfur vulcanization of at least one rubber mixture according to the invention including all of its preferred features.

As mentioned above, the present invention also provides a vehicle tire which in at least one component comprises at least one vulcanizate according to the invention including all of its preferred features.

In the context of the present invention “vehicle tires” are to be understood as meaning pneumatic vehicle tires and solid rubber tires, including tires for industrial and construction site vehicles, truck, car and two-wheeler tires.

Preference is given to a vehicle tire according to the invention which comprises at least one vulcanizate according to the invention including all of its preferred features at least in an outer component, preferably in the flange profile, tread and/or sidewall.

As mentioned above, the present invention further provides a process for producing the sulfur-crosslinkable rubber mixture according to the invention including all of its preferred features comprising at least the process steps of:
X1) providing a) 30 to 95 phr of at least one butadiene rubber; and
X2) providing b) 5 to 70 phr of at least one further rubber; and
X3) providing c) 0.1 to 3.0 phr of an oligomer mixture of 2,2,4-trimethyl-1,2-dihydroquinoline, wherein the mixture contains 70% to 100% by weight of dimers and trimers of 2,2,4-trimethyl-1,2-dihydroquinoline; and
X4) mixing the components from steps X1), X2) and X3),
wherein the reported amounts in phr relate to 100 parts by weight of the total mass of all rubbers in the produced sulfur-crosslinkable rubber mixture.

The mixing according to step X4) is preferably carried out in at least one primary mixing stage.

As mentioned above, the present invention further provides for the use of the sulfur-crosslinkable rubber mixture according to the invention including all of its preferred features for the production of technical rubber articles, such as bellows, conveyor belts, air springs, belts, drive belts or hoses, and also shoe soles.

The invention shall now be more particularly elucidated with reference to comparative and working examples summarized in the tables which follow.

All quantities in the tables are in phr unless otherwise stated.

### Substances Used

1) High-cis butadiene rubber, Co—BR, cis-1,4 content 95%
2) TMQ mixture: 43% by weight dimers and trimers of 2,2,4-trimethyl-1,2-dihydroquinoline, 0.1% by weight isopropylidene bis aniline, 1.0% by weight monomeric 2,2,4-trimethyl-1,2-dihydroquinoline; Vulkanox®, Lanxess
3) TMQ mixture: 75.5% by weight dimers and trimers of 2,2,4-trimethyl-1,2-dihydroquinoline, less than 0.01% by weight isopropylidene bis aniline, 0.5% by weight monomeric 2,2,4-trimethyl-1,2-dihydroquinoline; Sirantech™ S-TMQ, Jiangsu Sinorgchem Technology
4) Oil-extended sulfur: 33% by weight oil, 67% by weight sulfur
5) Silica: Zeosil® 1165MP, Solvay
6) Silane: Si 266 R, Evonik, contains TESPD (bis [3-triethoxysilyl) propyl]disulfide) 7) Steel cord adhesive system: Sum of cobalt stearate, resorcinol pre-condensate and hexamethoxymethylmelamine resin (HMMM 65%)
8) Silica: Ultrasil® VN 3 GR, Evonik
9) Hydrocarbon resin OPPERA PR 373N, ExxonMobil Chemical 10) Low-cis butadiene rubber, cis-1,4 content 39%

The mixtures were produced by the method customary in the rubber industry under standard conditions in least three stages in a laboratory mixer having a volume of 300 milliliters to 3 liters in which initially in the first mixing stages (primary mixing stages) all constituents except the vulcanization system (sulfur and vulcanization-influencing substances) were mixed at 145° C. to 165° C., with target temperatures of 152° C. to 157° C., for 200 to 600 seconds.

In the case of V3 and V4 an additional mastification was performed in which the natural rubber, zinc oxide and small fractions of the filler were premixed.

In a further stage the mixtures from the respective preceding stage were mixed again.

Addition of the vulcanization system in the third or fourth (V3 and V4) stage (final mixing stage) afforded the final mixture, mixing being carried out at 90° C. to 120° C. for 180 to 300 seconds.

All of the mixtures were used to prepare test specimens by vulcanization after t95 to t100 (measured on a moving die rheometer according to ASTM D 5289-12/ISO 6502) under pressure at 160° C. to 170° C. and these test specimens were used to determine material properties typical for the rubber industry by the test methods specified hereinbelow.
Shore hardness at room temperature (RT) according to ISO 868, DIN 53 505
Rebound resilience at 70° C. according to ISO 4662 or ASTM D 1054
Stress value at 100% elongation at room temperature (M100 RT) according to DIN 53 504
Dynamic storage modulus E′ at 55° C. from dynamic-mechanical measurement according to DIN 53 513, strain sweep at 8% elongation (E (8%))
Maximum (max) loss factor tan d, synonymous with tan delta, tan 8, at 55° C. from dynamic-mechanical measurement according to DIN 53 513, strain sweep.

Samples V2 and E2 were also aged for 14 days at 80° C. followed by determination of fatigue resistance to cracking and optionally fracture of the sample under dynamic load:
Monsanto Fatigue Test FTF: “Fatigue to failure” at 61% pre-elongation and room temperature, reported in kc (kilocycles), based on the method of ASTM D4482
Fatigue Test LTA: “Life time analysis” at 10% pre-elongation and room temperature, reported in kc (kilocycles), crack growth test with pre-induced crack under dynamic load: based on Monsanto Fatigue Test FTF

TABLE 1

| Constituent | Unit | V1 | E1 |
|---|---|---|---|
| NR TSR | phr | 30 | 30 |
| BR ¹⁾ | phr | 70 | 70 |
| N339 carbon | phr | 70 | 70 |
| black | | | |
| RAE | phr | 5 | 5 |
| ZnO | phr | 3 | 3 |
| Stearic acid | phr | 2 | 2 |
| Phenol resin | phr | 5 | 5 |
| 6PPD | phr | 2 | 2 |
| Antiozonant wax | phr | 2 | 2 |
| TMQ mixture ²⁾ | phr | 4 | — |
| TMQ mixture ³⁾ | phr | — | 2 |
| TBBS | phr | 2.5 | 2.5 |
| Sulfur ⁴⁾ | phr | 3.73 | 3.73 |
| Properties | | | |
| Shore hardness | Shore A | 74 | 75 |
| RT | | | |
| Rebound 70° C. | % | 56.5 | 58.3 |
| M 100 RT | MPa | 4.6 | 5.2 |
| E′ (8%) | MPa | 8.9 | 9.7 |
| Tan d (max) | | 0.198 | 0.182 |

TABLE 2

| Constituent | Unit | V2 | E2 |
|---|---|---|---|
| NR TSR | phr | 50 | 50 |
| BR ¹⁾ | phr | 50 | 50 |
| Silica ⁵⁾ | phr | 46 | 46 |
| Silane ⁶⁾ | phr | 3.3 | 3.3 |
| TDAE | phr | 5 | 5 |
| ZnO | phr | 3 | 3 |
| Stearic acid | phr | 2 | 2 |
| Phenol resin | phr | 2 | 2 |
| 6PPD | phr | 2 | 2 |
| Antiozonant wax | phr | 2 | 2 |
| TMQ mixture ²⁾ | phr | 4 | — |
| TMQ mixture ³⁾ | phr | — | 2 |
| DPG | phr | 2 | 2 |
| TBBS | phr | 1.5 | 1.5 |
| Sulfur | phr | 1.5 | 1.5 |
| Properties | | | |
| Shore hardness RT | Shore A | 60 | 60 |
| Rebound 70° C. | % | 65.7 | 66.4 |
| M 100 RT | MPa | 1.9 | 1.9 |
| E′ (8%) | MPa | 4.8 | 4.9 |
| Tan d (max) | | 0.093 | 0.082 |
| Properties after aging | | | |
| (14 days, 80° C.) | | | |
| Monsanto FTF RT | kc | 636 | 849 |
| 61% pre-elongation | | | |
| LTA RT 10% pre-elongation | kc | 333 | 2000 |
| | | | (Test end) |

TABLE 3

| Constituent | Unit | V3 | V4 |
|---|---|---|---|
| NR TSR | phr | 100 | 100 |
| N339 carbon black | phr | 62 | 62 |
| TDAE | phr | 2 | 2 |
| ZnO | phr | 7 | 7 |
| Phenol resin | phr | 1 | 1 |
| 6PPD | phr | 2 | 2 |
| TMQ mixture ²⁾ | phr | 4 | — |
| TMQ mixture ³⁾ | phr | — | 2 |
| Adhesive system ⁷⁾ | phr | 9.8 | 9.8 |
| DCBS | phr | 0.75 | 0.75 |
| Sulfur 4) | phr | 6.75 | 6.75 |
| Properties | | | |
| Shore hardness | Shore A | 78 | 80 |
| RT | | | |
| Rebound 70° C. | % | 49.2 | 49.1 |
| M 100 RT | MPa | 5.0 | 5.3 |
| Tan d (max) | | 0.176 | 0.175 |

TABLE 4

| Constituent | Unit | V5 | V6 |
|---|---|---|---|
| NR TSR | phr | 50 | 50 |
| SSBR | phr | 50 | 50 |
| N121 carbon | phr | 5 | 5 |
| black | | | |
| Silica ⁸⁾ | phr | 60 | 60 |
| Silane ⁶⁾ | phr | 5 | 5 |
| Resin ⁹⁾ | phr | 15 | 15 |
| ZnO | phr | 2.5 | 2.5 |
| Stearic acid | phr | 2 | 2 |
| 6PPD | phr | 1.5 | 1.5 |
| Antiozonant wax | phr | 2 | 2 |
| TMQ mixture ²⁾ | phr | 1.5 | — |
| TMQ mixture ³⁾ | phr | — | 0.75 |
| CBS | phr | 2 | 2 |
| Sulfur | phr | 1.5 | 1.5 |
| Properties | | | |
| Shore hardness | Shore A | 56 | 57 |
| RT | | | |
| Rebound 70° C. | % | 56.3 | 55.7 |
| M 100 RT | MPa | 1.3 | 1.4 |
| Tan d (max) | | 0.140 | 0.140 |

TABLE 5

| Constituent | Unit | V7 | E3 | V8 | E4 | V9 | E5 |
|---|---|---|---|---|---|---|---|
| NR TSR | phr | 30 | 30 | 70 | 70 | 70 | 70 |
| BR ¹⁾ | phr | — | — | 30 | 30 | 30 | 30 |
| BR ¹⁰⁾ | phr | 70 | 70 | — | — | — | — |
| N339 carbon black | phr | 70 | 70 | 70 | 70 | 70 | 70 |
| RAE | phr | 5 | 5 | 5 | 5 | 5 | 5 |
| ZnO | phr | 3 | 3 | 3 | 3 | 3 | 3 |
| Stearic acid | phr | 2 | 2 | 2 | 2 | 2 | 2 |
| Phenol resin | phr | 5 | 5 | 5 | 5 | 5 | 5 |
| 6PPD | phr | 2 | 2 | 2 | 2 | 2 | 2 |
| Antiozonant wax | phr | 2 | 2 | 2 | 2 | 2 | 2 |
| TMQ mixture ²⁾ | phr | 4 | — | 4 | — | 1.5 | — |
| TMQ mixture ³⁾ | phr | — | 2 | — | 2 | — | 0.75 |
| TBBS | phr | 2.5 | 2.5 | 2.5 | 2.5 | 2.5 | 2.5 |
| Sulfur ⁴⁾ | phr | 3.73 | 3.73 | 3.73 | 3.73 | 3.73 | 3.73 |
| Properties | | | | | | | |
| Shore hardness RT | Shore A | 75.5 | 76.5 | 74.7 | 74.8 | 75.5 | 75.8 |
| Rebound 70° C. | % | 55.1 | 56 | 51.7 | 52.9 | 53.3 | 53.6 |
| M 100 RT | MPa | 5.0 | 5.4 | 4.5 | 4.9 | 5.1 | 5.2 |
| E′ (8%) | MPa | | | 8.7 | 9.1 | 9.7 | 10.4 |
| Tan d (max) | | 0.193 | 0.185 | 0.195 | 0.184 | 0.189 | 0.182 |

TABLE 6

| Constituent | Unit | V10 | E6 | V11 | E7 | V12 | E8 | V13 | E9 |
|---|---|---|---|---|---|---|---|---|---|
| NR TSR | phr | — | — | — | — | 20 | 20 | 20 | 20 |
| BR ¹⁾ | phr | 50 | 50 | 50 | 50 | 30 | 30 | 30 | 30 |
| SSBR | phr | 50 | 50 | 50 | 50 | 50 | 50 | 50 | 50 |
| N339 carbon black | phr | 70 | 70 | 70 | 70 | 70 | 70 | 70 | 70 |
| RAE | phr | 5 | 5 | 5 | 5 | 5 | 5 | 5 | 5 |
| ZnO | phr | 3 | 3 | 3 | 3 | 3 | 3 | 3 | 3 |
| Stearic acid | phr | 2 | 2 | 2 | 2 | 2 | 2 | 2 | 2 |
| Phenol resin | phr | 5 | 5 | 5 | 5 | 5 | 5 | 5 | 5 |
| 6PPD | phr | 2 | 2 | 2 | 2 | 2 | 2 | 2 | 2 |
| Antiozonant wax | phr | 2 | 2 | 2 | 2 | 2 | 2 | 2 | 2 |
| TMQ mixture ²⁾ | phr | 4 | — | 1.5 | — | 4 | — | 1.5 | — |
| TMQ mixture ³⁾ | phr | — | 2 | — | 0.75 | — | 2 | — | 0.75 |
| TBBS | phr | 2.5 | 2.5 | 2.5 | 2.5 | 2.5 | 2.5 | 2.5 | 2.5 |
| Sulfur ⁴⁾ | phr | 3.73 | 3.73 | 3.73 | 3.73 | 3.73 | 3.73 | 3.73 | 3.73 |
| Properties | | | | | | | | | |
| Shore hardness RT | Shore A | 76.8 | 77.1 | 77.3 | 77.8 | 75.3 | 76 | 76.7 | 76.7 |
| Rebound 70° C. | % | 54.3 | 55.7 | 55.8 | 56.1 | 54.1 | 55.3 | 54.2 | 55.7 |
| M 100 RT | MPa | 5.2 | 5.8 | 5.8 | 5.9 | 5 | 5.4 | 5.4 | 5.6 |
| E′ (8%) | MPa | 11.7 | 12.2 | 12.4 | 12.8 | 10.6 | 10.8 | 11.3 | 11.5 |
| Tan d (max) | | 0.193 | 0.186 | 0.185 | 0.183 | 0.195 | 0.188 | 0.194 | 0.187 |

As is apparent from tables 1 to 6 surprisingly only the combination of a) butadiene rubber in the amounts according to the invention and c) the oligomer mixture of TMQ containing 70% to 100% by weight of dimers and trimers achieves improved rebound elasticities at 70° C. and improved heat buildup (lower values for hysteresis loss, tan delta) and thus further improved rolling resistance indicators and improved handling indicators.

In addition, mixture E2 comprising a) 50 phr of BR and c) the oligomer mixture of TMQ containing 70% to 100% by weight of dimers and trimers surprisingly shows markedly improved fatigue resistance, in particular with respect to cracking and optionally fracture, after aging.

1-14. (canceled)

15. A sulfur-crosslinkable rubber mixture containing at least the following constituents:
a) 30 to 95 phr of at least one butadiene rubber; and
b) 5 to 70 phr of at least one further rubber; and
c) 0.1 to 3.0 phr of an oligomer mixture of 2,2,4-trimethyl-1,2-dihydroquinoline,
wherein the mixture contains 70% to 100% by weight of dimers and trimers of 2,2,4-trimethyl-1,2-dihydroquinoline.

16. The sulfur-crosslinkable rubber mixture according to claim 15, wherein the at least one butadiene rubber is present from 40 to 95 phr.

17. The sulfur-crosslinkable rubber mixture according to claim 15, wherein the at least one butadiene rubber is present from 50 to 95 phr.

18. The sulfur-crosslinkable rubber mixture according to claim 15, wherein the at least one further rubber is present from 5 to 60 phr.

19. The sulfur-crosslinkable rubber mixture according to claim 15, wherein the oligomer mixture of 2,2,4-trimethyl-1,2-dihydroquinoline is present from 0.2 to 3 phr.

20. The sulfur-crosslinkable rubber mixture according to claim 15, wherein the oligomer mixture of 2,2,4-trimethyl-1,2-dihydroquinoline is present from 0.2 to 2.5 phr.

21. The sulfur-crosslinkable rubber mixture according to claim 15, wherein the at least one further rubber b) is at least one diene rubber selected from the group consisting of natural polyisoprene (NR) and synthetic polyisoprene (IR) and styrene-butadiene rubber (SBR).

22. The sulfur-crosslinkable rubber mixture according to claim 21, wherein the styrene-butadiene rubber is solution-polymerized styrene-butadiene rubber (SSBR).

23. The sulfur-crosslinkable rubber mixture according to claim 21, wherein it contains as rubber b) 5 to 40 phr of natural polyisoprene (NR).

24. The sulfur-crosslinkable rubber mixture according to claim 15, wherein the sulfur-crosslinkable rubber mixture contains a) 60 to 80 phr at least of one butadiene rubber and b) 20 to 40 phr at least of one natural polyisoprene (NR).

25. The sulfur-crosslinkable rubber mixture according to claim 15, wherein it contains a) 40 to 60 phr of at least one butadiene rubber and b) 40 to 60 phr of at least one natural polyisoprene (NR).

26. The sulfur-crosslinkable rubber mixture according to claim 15, wherein the at least one butadiene rubber a) has a cis-1,4 content of 90% to 98%.

27. The sulfur-crosslinkable rubber mixture according to claim 15, wherein the oligomer mixture c) contains 73% to 100% by weight of dimers and trimers of 2,2,4-trimethyl-1,2-dihydroquinoline.

28. The sulfur-crosslinkable rubber mixture according to claim 15, wherein the oligomer mixture contains the substance isopropylidene bis aniline in an amount of less than 0.05% by weight.

29. The sulfur-crosslinkable rubber mixture according to claim 15, wherein the oligomer mixture contains the monomer 2,2,4-trimethyl-1,2-dihydroquinoline in an amount of less than 0.7% by weight.

30. The sulfur-crosslinkable rubber mixture according to claim 15, wherein it contains d) at least one filler in an amount from 20 to 500 phr.

31. The sulfur-crosslinkable rubber mixture according to claim 30, wherein the at least one filler includes 20 to 180 phr of at least one carbon black.

32. A vehicle tire, wherein it comprises at least one vulcanizate obtained by sulfur vulcanization of the at least one rubber mixture according to claim 15 formed in at least one component of the tire.

33. The vehicle tire according to claim 32, wherein it comprises the at least one vulcanizate at least in an outer component of the tire.

34. A process for producing the sulfur-crosslinkable rubber mixture as according to claim 15, comprising at least the process steps of:
X1) providing a) 30 to 95 phr of at least one butadiene rubber; and
X2) providing b) 5 to 70 phr of at least one further rubber, and
X3) providing c) 0.1 to 3.0 phr of an oligomer mixture of 2,2,4-trimethyl-1,2-dihydroquinoline, wherein the mixture contains 70% to 100% by weight of dimers and trimers of 2,2,4-trimethyl-1,2-dihydroquinoline; and
X4) mixing the components from steps X1), X2) and X3),
wherein the reported amounts in phr relate to 100 parts by weight of the total mass of all rubbers in the produced sulfur-crosslinkable rubber mixture.
